(19) United States
(12) Patent Application Publication
(10) Pub. No.: US 2024/0386387 A1
(43) Pub. Date: Nov. 21, 2024

(54) SCHEDUALIZATION OF ACTIVITIES THROUGH VIRTUAL REALITY BASED ON PREDICTED EVENTS

(71) Applicant: INTERNATIONAL BUSINESS MACHINES CORPORATION, ARMONK, NY (US)

(72) Inventors: Michael Boone, Lutz, FL (US); Jeremy R. Fox, Georgetown, TX (US); Sarbajit K. Rakshit, Kolkata (IN); Tushar Agrawal, West Fargo, ND (US)

(21) Appl. No.: 18/318,389

(22) Filed: May 16, 2023

(51) Int. Cl. G06Q 10/1093

(52) U.S. Cl. CPC G06Q 10/1093

(57) ABSTRACT

An embodiment for scheduling activities through virtual reality (VR) based on predicted events is provided. The embodiment may include receiving real-time data relating to a predicted event and historical data relating to a corresponding past event. The embodiment may also include identifying a context of the predicted event. The embodiment may further include generating a VR simulation of the predicted event. The VR simulation may include an avatar of a user in a surrounding environment of the predicted event. The embodiment may also include scheduling one or more activities for the user in response to one or more scheduling actions of the user. The embodiment may further include recommending one or more additional activities to the user.

### BACKGROUND

The present invention relates generally to the field of computing, and more particularly to a system for scheduling activities through virtual reality (VR) based on predicted events.

VR may be used to create a simulated environment for a user, such as training the user on how to perform a task, or allowing the user to experience a task before actually performing the task. VR technology is increasingly being used in marketing to create immersive and interactive experiences for customers. When the user wishes to add an event to a digital calendar, it may be difficult for the user to manage several concurrent events. Information relevant to attempts to address this problem can be found in U.S. Pat. Nos. 11,159,460, 11,068,855, and 10,909,506. However, each one of these references suffers from one or more of the following disadvantages: a failure to utilize VR to enable event management operations; and a failure to fully immerse the user into a VR environment such that the user can plan their experience.

### SUMMARY

According to one embodiment, a method, computer system, and computer program product for scheduling activities through virtual reality (VR) based on predicted events is provided. The embodiment may include receiving real-time data relating to a predicted event and historical data relating to a corresponding past event. The embodiment may also include identifying a context of the predicted event based on the real-time and the historical data. The embodiment may further include generating a VR simulation of the predicted event based on the identified context and the historical data. The VR simulation may include an avatar of a user in a surrounding environment of the predicted event. The embodiment may also include scheduling one or more activities for the user in response to one or more scheduling actions of the user. The embodiment may further include recommending one or more additional activities to the user based on the historical data. This embodiment has the advantage of enabling the user to schedule activities to prepare for future events through VR.

According to at least one other embodiment, in response to determining there is at least one additional VR simulation linked to the VR simulation, one or more VR components in each linked VR simulation may be identified. The embodiment may also include generating a singular dynamic VR simulation incorporating at least one VR component from each linked VR simulation. This embodiment has the advantage of consolidating multiple VR simulations into a single VR simulation.

According to at least one further embodiment, incorporating the at least one VR component from each linked VR simulation may further include dynamically displaying the at least one VR component from each linked VR simulation to multiple linked users in an order from highest priority to lowest priority. This embodiment has the advantage of dynamically changing the VR components that are displayed to the multiple users.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIGS. 2A and 2B illustrate an operational flowchart for scheduling activities through virtual reality (VR) based on predicted events in a VR activity scheduling process according to at least one embodiment.

FIG. 3 is an exemplary diagram depicting multiple VR simulations that are linked together according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for scheduling activities through virtual reality (VR) based on predicted events. The following described exemplary embodiments provide a system, method, and program product to, among other things, generate a VR simulation of a predicted event based on an identified context of the predicted event and historical data and, accordingly, schedule one or more activities for the user in response to one or more scheduling actions. Therefore, the present embodiment has the capacity to improve VR technology by increasing the efficiency and effectiveness of VR collaborations.

As previously described, VR may be used to create a simulated environment for a user, such as training the user on how to perform a task, or allowing the user to experience a task before actually performing the task. VR technology is increasingly being used in marketing to create immersive and interactive experiences for customers. When the user wishes to add an event to a digital calendar, it may be difficult for the user to manage several concurrent events. This problem is typically addressed by automatically scheduling events for the user based on event history. However, automatically scheduling events fails to enable the user to schedule activities to prepare for future events through VR.

It may therefore be imperative to have a system in place to enable the user to schedule activities to prepare for future events utilizing a VR interface.

According to at least one embodiment, when a user wishes to schedule activities, real-time data relating to a predicted event and historical data relating to a corresponding past event may be received in order to identify a context of the predicted event based on the real-time and the historical data. Upon identifying the context, a VR simulation of the predicted event may be generated based on the identified context and the historical data. The VR simulation may include an avatar of the user in a surrounding environment of the predicted event. Then, one or more activities for the user may be scheduled in response to one or more scheduling actions of the user so that one or more additional activities may be recommended to the user based on the historical data. This embodiment has the advantage of enabling the user to schedule activities to prepare for future events through VR.

According to at least one other embodiment, the VR simulation of the predicted event may be replayed in response to a request of the user. This embodiment has the advantage of enabling the user to experience the VR simulation on demand.

According to at least one further embodiment, in response to determining there is at least one additional VR simulation linked to the VR simulation, one or more VR components in each linked VR simulation may be identified such that a singular dynamic VR simulation incorporating at least one VR component from each linked VR simulation may be generated. This embodiment has the advantage of consolidating multiple VR simulations into a single VR simulation.

According to at least one other embodiment, upon generating the singular dynamic VR simulation incorporating the at least one VR component from each linked VR simulation, the at least one VR component from each linked VR simulation may be dynamically displayed to multiple linked users in an order from highest priority to lowest priority. This embodiment has the advantage of dynamically changing the VR components that are displayed to the multiple users.

The present invention does not require that all advantages need to be incorporated into every embodiment of the invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to generate a VR simulation of a predicted event based on an identified context of the predicted event and historical data and, accordingly, schedule one or more activities for the user in response to one or more scheduling actions.

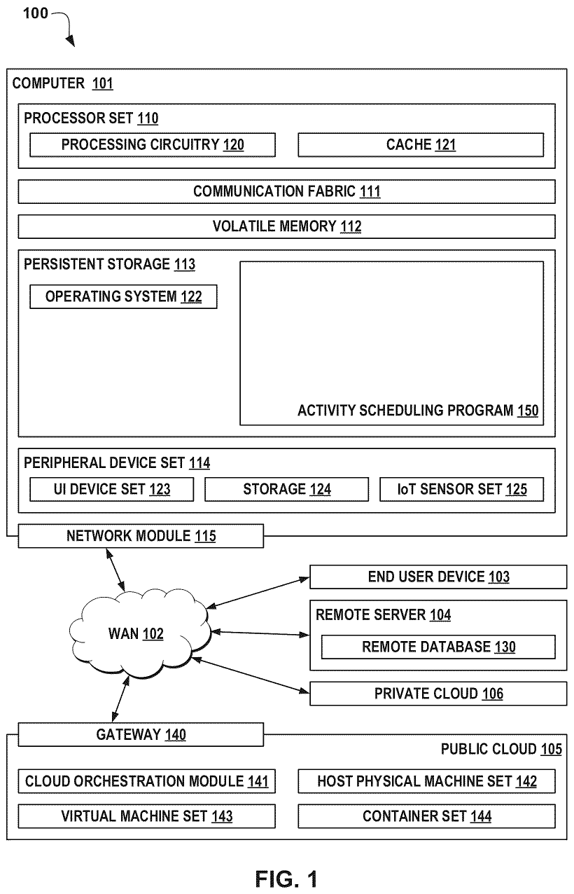

Referring to FIG. 1, an exemplary computing environment 100 is depicted, according to at least one embodiment. Computing environment 100 contains an example of an environment for the execution of at least some of the computer code involved in performing the inventive methods, such as an activity scheduling program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a VR headset and/or any other device for enhancing the reality of the user.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

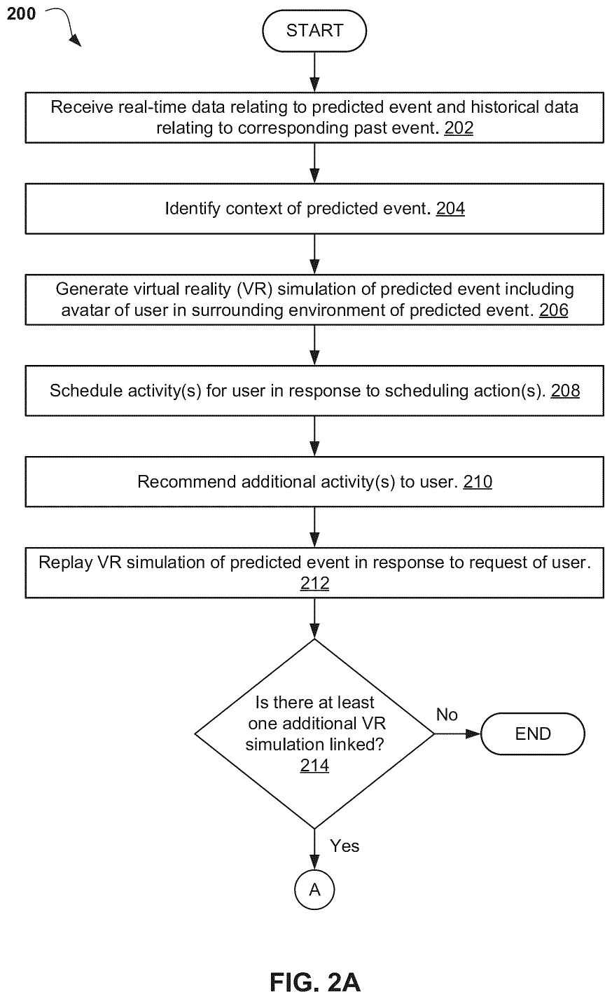

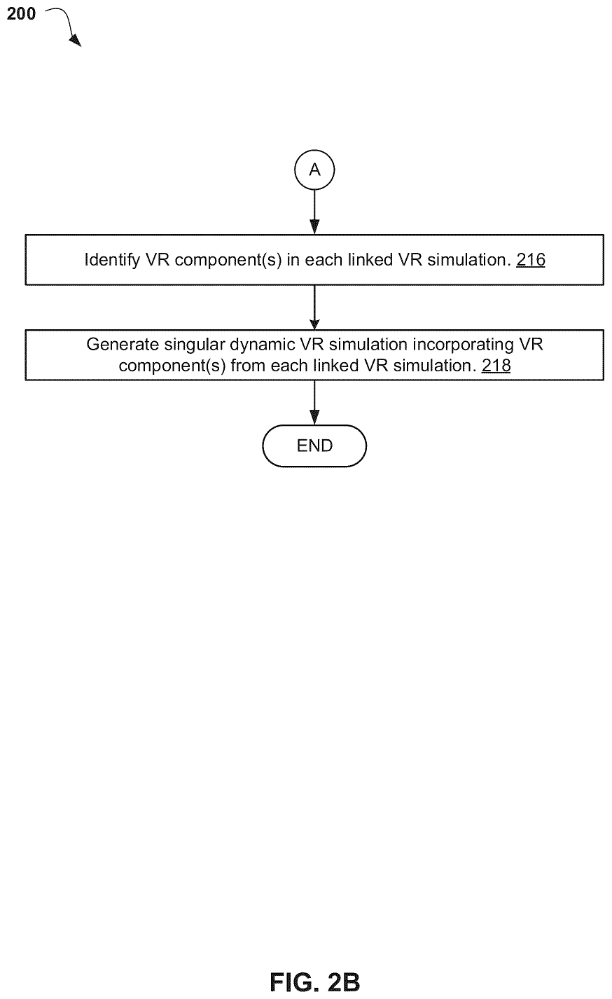

According to the present embodiment, the activity scheduling program 150 may be a program capable of receiving real-time data relating to a predicted event and historical data relating to a corresponding past event, generating a VR simulation of the predicted event based on an identified context of the predicted event and the historical data, scheduling one or more activities for the user in response to one or more scheduling actions, enabling the user to schedule activities to prepare for future events through VR, consolidating multiple VR simulations into a single VR simulation, and dynamically changing the VR components that are displayed to multiple users. Furthermore, notwithstanding depiction in computer 101, the activity scheduling program 150 may be stored in and/or executed by, individually or in any combination, end user device 103, remote server 104, public cloud 105, and private cloud 106. The activity scheduling method is explained in further detail below with respect to FIGS. 2A and 2B. It may be appreciated that the examples described below are not intended to be limiting, and that in embodiments of the present invention the parameters used in the examples may be different.

Referring now to FIGS. 2A and 2B, an operational flowchart for scheduling activities through VR based on predicted events in a VR activity scheduling process 200 is depicted according to at least one embodiment. At 202, the activity scheduling program 150 receives the real-time data relating to the predicted event and the historical data relating to the corresponding past event. The predicted event may be an event that will occur in the future. Examples of the predicted event may include, but are not limited to, a work event (e.g., an office party), a weather event (e.g., a snowstorm), and/or a holiday event (e.g., Independence Day).

The real-time data may include, but is not limited to, a type of event, a likelihood of the event (e.g., probability the event will occur), a duration of the event, and/or activities associated with the event. For example, the type of event may be a snowstorm that is expected to last approximately 12 hours. Continuing the example, the activities associated with the snowstorm may include getting gas for a car and/or generator, buying batteries, shovels, and flashlights, and/or changing the tires on the car.

The corresponding past event may be an event of the same type as the predicted event. For example, where the predicted event is a snowstorm, the corresponding past event may also be the snowstorm. The historical data may include, but is not limited to, activities the user performed during the corresponding past event, activities the user forgot to perform during the corresponding past event, a likelihood of the corresponding past event occurring again, and/or an importance of the corresponding past event. The historical data may be contained in a knowledge corpus, such as remote database 130. For example, where the corresponding past event is the snowstorm, the user may have bought gas for the generator but may have forgotten to buy oil as well. Continuing the example, the snowstorm may be classified as a highly important event. In another example, the corresponding past event may be an office party. Continuing the example, the office party may be classified as a moderately important event.

Then, at 204, the activity scheduling program 150 identifies the context of the predicted event. The context is identified based on the real-time and the historical data. The context of the predicted event may include the time and the location at which the predicted event will occur. For example, where the predicted event is the snowstorm, the weather forecast may predict the snowstorm is expected in the New York City Metropolitan area between the hours of 2:00 p.m. and 2:00 a.m. on February 14th (i.e., 12 hours).

A non-weather event may be more predictable than a weather event. Thus, the historical data may be relied on more heavily to identify the context of the non-weather event. For example, an office party may occur on the last Friday of the month from 3:00 p.m.-5:00 p.m. each month in conference room “B”. In this example, the corresponding past event may be the recurring office party, and the historical data may include the information that the office party occurs on the last Friday of the month from 3:00 p.m.-5:00 p.m. each month in conference room “B”. In this manner, the activity scheduling program 150 may identify the predicted event as the office party, and the context may be that the office party will occur in conference room “B” this coming Friday from 3:00 p.m.-5:00 p.m.

Next, at 206, the activity scheduling program 150 generates the VR simulation of the predicted event. The VR simulation is generated based on the identified context and the historical data, and the VR simulation includes the avatar of the user in the surrounding environment of the predicted event. The avatar of the user may be created according to known techniques in accordance with the characteristics of the user. The created avatar may then be fully immersed in the VR simulation. In this manner, the user may experience the predicted event in the virtual world.

For example, the predicted event may be the snowstorm. The weather forecast may predict the snowstorm is expected in the New York City Metropolitan area between the hours of 2:00 p.m. and 2:00 a.m. on February 14^{th} (i.e., 12 hours). However, since the area of the snowstorm is very large, it may be desirable to narrow the location down to where the user will actually experience the storm, such as a home or apartment of the user. The activity scheduling program 150 may utilize the historical data from a corresponding past event of a similar context to recreate the corresponding past event. Thus, if the power goes out in the apartment or home of the user during the corresponding past event, then during the VR simulation the power may also go out. If the user drives their car in the snow and skids during the corresponding past event, then during the VR simulation the car may also skid.

In another example, the predicted event may be the office party. The historical data may indicate the office party occurs on the last Friday of the month from 3:00 p.m.-5:00 p.m. each month in conference room “B”. The activity scheduling program 150 may utilize the historical data from a corresponding past event of a similar context to recreate the corresponding past event. Thus, if a coworker of the user buys bagels during the corresponding past event, then during the VR simulation the coworker may also buy and bring bagels to conference room “B”. If several coworkers of the user are wearing a themed sweater during the corresponding past event, then during the VR simulation those coworkers may also wear the themed sweater.

According to at least one embodiment, the user may proceed through the VR simulation at a faster speed to save time. For example, where the snowstorm is expected to last 12 hours, the user may not want to sit through a 12 hour VR simulation. Continuing the example, the user may proceed through the VR simulation at 2x, 3x, etc. the speed.

Then, at 208, the activity scheduling program 150 schedules the one or more activities for the user. The one or more activities are scheduled in response to the one or more scheduling actions of the user. It may be appreciated that in embodiments of the present invention, the user may schedule activities as the user progresses through the generated VR simulation.

According to at least one embodiment, scheduling the one or more activities for the user may include adding the scheduled one or more activities to a digital calendar of the user. For example, the digital calendar may be a mobile application on a smartphone of the user. During the VR simulation, the user may be presented with a holographic media progress bar. The one or more scheduling actions of the user may include one or more interactions of the user with the holographic media progress bar at different points of the VR simulation. Examples of the interaction may include, but are not limited to, pointing towards the holographic media progress bar, making a swiping gesture along the holographic media progress bar, and/or making an eye gesture (e.g., blinking). The scheduled one or more activities may then be added to the digital calendar of the user in response to the interaction of the user with the holographic media progress bar.

For example, during the VR simulation of the snowstorm, when the power goes out, the user may interact with the holographic media progress bar to schedule buying batteries, a flashlight, and/or gasoline. Additionally, during the VR simulation of the snowstorm, when the car skid, the user may interact with the holographic media progress bar to schedule buying winter tires. In this manner, the user may be prepared for the snowstorm in advance.

In another example, during the VR simulation of the office party, when the coworker of the user buys bagels, the user may interact with the holographic media progress bar to schedule buying cream cheese and/or butter. Additionally, during the VR simulation of the office party, when several coworkers of the user are wearing a themed sweater, the user may interact with the holographic media progress bar to schedule buying the themed sweater.

Next, at 210, the activity scheduling program 150 recommends the one or more additional activities to the user. The one or more additional activities are recommended based on the historical data. As described above with respect to step 202, the historical data may include, but is not limited to, activities the user performed during the corresponding past event, activities the user forgot to perform during the corresponding past event, a likelihood of the corresponding past event occurring again, and/or an importance of the corresponding past event. The historical data may be utilized to train a machine learning model to predict the types of activities the user should perform in response to the predicted event and make recommendations accordingly. Examples of the machine learning model may include, but are not limited to, a decision tree, a convolutional neural network, support vector machines, k-nearest neighbors, and/or random forests. The models may be continuously updated as predicted events actually occur.

According to at least one embodiment, at least one recommended additional activity of the recommended one or more additional activities may include a critical activity the user forgot to schedule during the corresponding past event. For example, where the corresponding past event is the snowstorm, the user may have bought gas for the generator but may have forgotten to buy oil as well. Continuing the example, the snowstorm may be classified as a highly important event, and thus buying oil may be the critical activity. In this example, the activity scheduling program 150 may recommend that the user schedules buying the oil. The recommendation may be a digital image overlay adjacent to the holographic media progress bar. For example, an image of an oil container may be displayed above the holographic media progress bar.

According to at least one other embodiment, the one or more additional activities may only be recommended when the probability of the predicted event occurring exceeds a probability threshold. For example, assuming the probability threshold is 30%, where the probability of the snowstorm occurring is greater than 30%, the activity scheduling program 150 may recommend that the user schedules buying the oil. Continuing the example, where the probability of the snowstorm occurring is less than 30%, the activity scheduling program 150 may not recommend that the user schedules buying the oil.

Then, at 212, the activity scheduling program 150 replays the VR simulation of the predicted event. The VR simulation may be replayed in response to the request of the user. The VR simulation may be stored in the knowledge corpus, such as remote database 130, and may be replayed on demand. As described above with respect to step 206, the user may proceed through the replay of the VR simulation at 2x, 3x, etc. the speed.

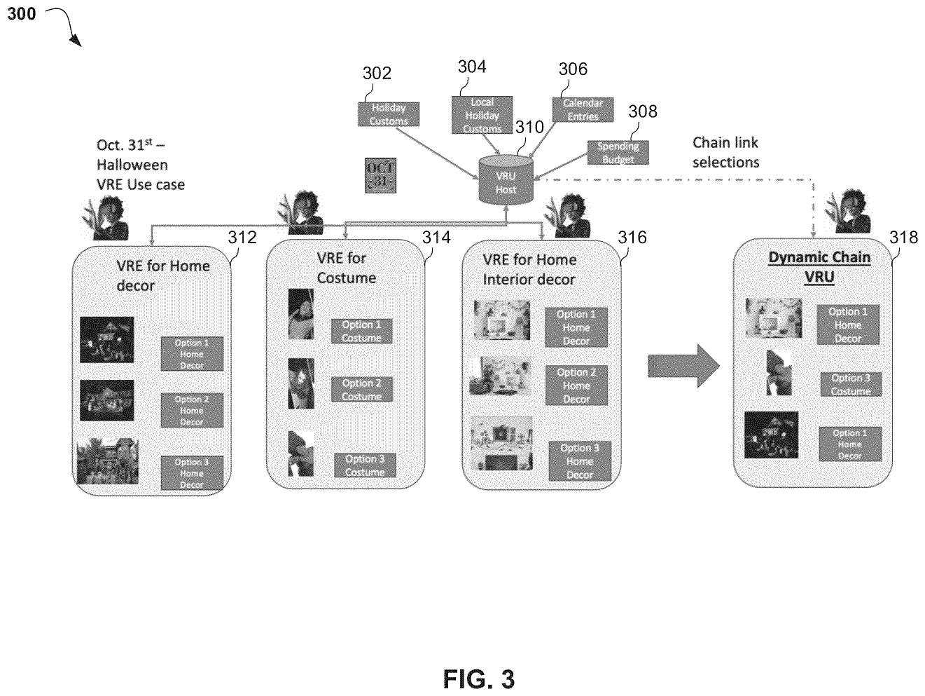

Next, at 214, the activity scheduling program 150 determines whether there is at least one additional VR simulation linked to the VR simulation. According to at least one embodiment, the user may be part of a shared account comprising multiple users. For example, the account of the user may be a family account where each family member has their own profile on the account. In another example, the account of the user may be a work account where each employee has their own profile on the account. Each of these family members or employees may be presented with a different VR simulation, described in further detail below with respect to the description of FIG. 3. Thus, the VR simulation and the at least one additional VR simulation may be linked together under the same account.

In response to determining there is the at least one additional VR simulation (step 214, “Yes” branch), the VR activity scheduling process 200 proceeds to step 216 to identify the one or more VR components in each linked VR simulation. In response to determining there is not the at least one additional VR simulation (step 214, “No” branch), the VR activity scheduling process 200 ends.

Then, at 216, the activity scheduling program 150 identifies the one or more VR components in each linked VR simulation. As described above with respect to step 214, the multiple users may be viewing different VR simulations that are linked together, described in further detail below with respect to the description of FIG. 3. Each of these VR simulations may include various components. For example, the components of a first additional VR simulation may include different houses that are decorated for a holiday. Continuing the example, the components of a second additional VR simulation may include different themed shirts for a holiday party. The one or more components in each linked VR simulation may be displayed sequentially. For example, where the components of the first additional VR simulation include different houses that are decorated for a holiday, a first decorated house may be displayed, then a second decorated house, followed by a third decorated house, and so on.

Next, at 218, the activity scheduling program 150 generates the singular dynamic VR simulation incorporating the at least one VR component from each linked VR simulation. The singular dynamic VR simulation may be displayed to each user and may include at least one VR component from each linked VR simulation, described in further detail below with respect to the description of FIG. 3. For example, where the components of the first additional VR simulation include different houses that are decorated for a holiday, and where the components of the second additional VR simulation include different themed shirts for a holiday party, the singular dynamic VR simulation may include at least one decorated house and at least one themed shirt.

According to at least one embodiment, incorporating the at least one VR component from each linked VR simulation may include dynamically displaying the at least one VR component from each linked VR simulation to the multiple linked users in an order from highest priority to lowest priority. Each linked VR simulation and the components therein may be ranked based on the importance of the predicted event. For example, the first additional VR simulation that includes the decorated houses may be ranked first, and the second additional VR simulation that includes the themed shirts may be ranked second. Continuing the example, in the singular dynamic VR simulation, the decorated houses may be displayed, followed by the themed shirts. In this manner, the components of the singular dynamic VR simulation may constantly be changing.

Referring now to FIG. 3, a diagram 300 depicting multiple VR simulations 312, 314, 316 that are linked together is shown according to at least one embodiment. In the diagram 300, multiple users may be preparing for a Halloween party. Holiday customs data 302, local holiday customs data 304, calendar entries data 306, and spending budget data 308 may be input into and contained in a virtual reality unit host 310. A first user may be viewing a VR simulation of home décor options 312. For example, the VR simulation of home décor options 312 may include home décor option 1, home décor option 2, and home décor option 3. A second user may be viewing a VR simulation of costume options 314. For example, the VR simulation of costume options 314 may include costume option 1, costume option 2, and costume option 3. A third user may be viewing a VR simulation of interior home décor options 316. For example, the VR simulation of interior home décor options 316 may include interior home décor option 1, interior home décor option 2, and interior home décor option 3. Assuming the multiple VR simulations 312, 314, 316 VR are of the same priority (e.g., medium priority), it may be necessary to determine the sequence of the dynamic chain VRU 318 (i.e., the singular dynamic VR simulation) based on the priority of the individual components. For example, in the embodiment of FIG. 3, interior home décor option 1 may be ranked as highest priority, costume option 3 may be ranked as medium priority, and home décor option 1 may be ranked as lowest priority. Thus, in the dynamic chain VRU 318, interior home décor option 1 may be displayed to the multiple users first, costume option 3 may be displayed to the multiple users second, and home décor option 1 may be displayed to the multiple users third.

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of scheduling activities through virtual reality (VR), the method comprising:
receiving real-time data relating to a predicted event and historical data relating to a corresponding past event;
identifying a context of the predicted event based on the real-time and the historical data;
generating a VR simulation of the predicted event based on the identified context and the historical data, wherein the VR simulation includes an avatar of a user in a surrounding environment of the predicted event;
scheduling one or more activities for the user in response to one or more scheduling actions of the user; and
recommending one or more additional activities to the user based on the historical data.

2. The computer-based method of claim 1, further comprising:
replaying the VR simulation of the predicted event in response to a request of the user.

3. The computer-based method of claim 1, further comprising:
determining whether there is at least one additional VR simulation linked to the VR simulation; and
in response to determining there is the at least one additional VR simulation:
identifying one or more VR components in each linked VR simulation; and
generating a singular dynamic VR simulation incorporating at least one VR component from each linked VR simulation.

4. The computer-based method of claim 3, wherein incorporating the at least one VR component from each linked VR simulation further comprises:
dynamically displaying the at least one VR component from each linked VR simulation to multiple linked users in an order from highest priority to lowest priority.

5. The computer-based method of claim 1, wherein scheduling one or more activities for the user further comprises:
adding the scheduled one or more activities to a digital calendar of the user.

6. The computer-based method of claim 5, wherein the scheduled one or more activities are added to the digital calendar of the user in response to an interaction of the user with a holographic media progress bar.

7. The computer-based method of claim 1, wherein at least one recommended additional activity of the recommended one or more additional activities includes a critical activity the user forgot to schedule during the corresponding past event.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time data relating to a predicted event and historical data relating to a corresponding past event;
identifying a context of the predicted event based on the real-time and the historical data;
generating a virtual reality (VR) simulation of the predicted event based on the identified context and the historical data, wherein the VR simulation includes an avatar of a user in a surrounding environment of the predicted event;
scheduling one or more activities for the user in response to one or more scheduling actions of the user; and
recommending one or more additional activities to the user based on the historical data.

9. The computer system of claim 8, the method further comprising:
replaying the VR simulation of the predicted event in response to a request of the user.

10. The computer system of claim 8, the method further comprising:
determining whether there is at least one additional VR simulation linked to the VR simulation; and
in response to determining there is the at least one additional VR simulation:
identifying one or more VR components in each linked VR simulation; and
generating a singular dynamic VR simulation incorporating at least one VR component from each linked VR simulation.

11. The computer system of claim 10, wherein incorporating the at least one VR component from each linked VR simulation further comprises:
dynamically displaying the at least one VR component from each linked VR simulation to multiple linked users in an order from highest priority to lowest priority.

12. The computer system of claim 8, wherein scheduling one or more activities for the user further comprises:
adding the scheduled one or more activities to a digital calendar of the user.

13. The computer system of claim 12, wherein the scheduled one or more activities are added to the digital calendar of the user in response to an interaction of the user with a holographic media progress bar.

14. The computer system of claim 8, wherein at least one recommended additional activity of the recommended one or more additional activities includes a critical activity the user forgot to schedule during the corresponding past event.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time data relating to a predicted event and historical data relating to a corresponding past event;
identifying a context of the predicted event based on the real-time and the historical data;
generating a virtual reality (VR) simulation of the predicted event based on the identified context and the historical data, wherein the VR simulation includes an avatar of a user in a surrounding environment of the predicted event;
scheduling one or more activities for the user in response to one or more scheduling actions of the user; and
recommending one or more additional activities to the user based on the historical data.

16. The computer program product of claim 15, the method further comprising:
replaying the VR simulation of the predicted event in response to a request of the user.

17. The computer program product of claim 15, the method further comprising:
determining whether there is at least one additional VR simulation linked to the VR simulation; and
in response to determining there is the at least one additional VR simulation:
identifying one or more VR components in each linked VR simulation; and
generating a singular dynamic VR simulation incorporating at least one VR component from each linked VR simulation.

18. The computer program product of claim 17, wherein incorporating the at least one VR component from each linked VR simulation further comprises:
dynamically displaying the at least one VR component from each linked VR simulation to multiple linked users in an order from highest priority to lowest priority.

19. The computer program product of claim 15, wherein scheduling one or more activities for the user further comprises:
adding the scheduled one or more activities to a digital calendar of the user.

20. The computer program product of claim 19, wherein the scheduled one or more activities are added to the digital calendar of the user in response to an interaction of the user with a holographic media progress bar.
